(19) United States
(12) Patent Application Publication
(10) Pub. No.: US 2025/0036720 A1
(43) Pub. Date: Jan. 30, 2025

(54) SYSTEMS, APPARATUSES, METHODS, AND COMPUTER PROGRAM PRODUCTS FOR INTELLIGENT REPORT CONFIGURATION

(71) Applicant: Honeywell International Inc., Charlotte, NC (US)

(72) Inventors: Ankit Singh, Apex, NC (US); Arun Ramasubrahmanyan, Burlington, NJ (US); Timothy Sneed, Beachwood, NJ (US); Abhishek Hiremath, Bellevue, WA (US)

(21) Appl. No.: 18/361,393

(22) Filed: Jul. 28, 2023

(51) Int. Cl. G06F 17/40; G06F 11/30

(52) U.S. Cl. CPC G06F 17/40; G06F 11/3065

(57) ABSTRACT

Embodiments provide for intelligent report configuration. Some embodiments aggregate historical configuration data based at least in part on a plurality of historical reports, receive a signal indicative of a configuration request for a report having a hierarchical data structure, identify at least one configuration node of a report configuration workflow for configuring the report. The report configuration workflow may be defined by a hierarchical arrangement of a plurality of configuration nodes. Some embodiments generate, based at least in part on the historical configuration data and using one or more models, one or more data objects for the at least one configuration node. The one or more data objects may be indicative of at least a portion of the configuration data for one or more portions of the report. Some embodiments cause display of the one or more data objects on a configuration user interface rendered on a user device.

### TECHNICAL FIELD

Embodiments of the present disclosure generally relate to configuring reports, and specifically to intelligently providing configuration data.

### BACKGROUND

Various embodiments of the present disclosure address technical challenges associated with configuring reports. Through applied effort, ingenuity, and innovation, Applicant has solved problems associated with configuring reports by developing solutions embodied in the present disclosure, which are described in detail below.

### BRIEF SUMMARY

In one aspect, a computer-implemented method for intelligent report configuration is provided. The example computer-implemented method includes aggregating historical configuration data based at least in part on a plurality of historical reports; receiving a signal indicative of a configuration request for a report having a hierarchical data structure; identifying at least one configuration node of a report configuration workflow for configuring the report, the report configuration workflow defined by a hierarchical arrangement of a plurality of configuration nodes corresponding to the hierarchical data structure of the report; generating, based at least in part on the historical configuration data and using one or more models, one or more data objects for the at least one configuration node, the one or more data objects indicative of at least a portion of the configuration data for one or more portions of the report; causing display of the one or more data objects on a configuration user interface rendered on a user device.

The computer-implemented method, where the signal is received from the user device.

The computer-implemented method, where the plurality of historical reports are associated with a plurality of entities having at least one characteristic in common.

The computer-implemented method, where the plurality of historical reports are associated with an individual entity.

The computer-implemented method, where the plurality of configuration nodes includes at least one chapter configuration node configured for defining one or more chapters for the report, and one or more user configuration nodes for each of the one or more chapters, where each user configuration node for a chapter is configured to enable configuration of one or more user assignments for the chapter.

The computer-implemented method, where the plurality of configuration nodes further includes one or more chart configuration nodes for each of the one or more chapters, where each chart configuration node for a chapter is configured to enable configuration of one or more charts for the chapter.

The computer-implemented method, where at least one model of the one or more models is trained to generate at least one data object for each of the one or more chapters based at least in part on a similarity measure between subsets of the historical configuration data, where each subset of the historical configuration data is associated with a particular historical report of the plurality of historical reports.

The computer-implemented method, where at least one model of the one or more models is trained to generate at least one data object for each of the one more chapters based at least in part on the historical configuration data and real-time data indicative of at least a workload for each of one or more candidate users.

The computer-implemented method, where the configuration user interface includes one or more of a chapter configuration user interface, a user configuration user interface, a chart configuration user interface, or a table configuration user interface.

The computer-implemented method, where the historical configuration data includes one or more segments, where each segment corresponds to a particular configuration node of the plurality of configuration nodes.

In another aspect, an apparatus for intelligent report configuration is provided. The example apparatus includes at least one processor and at least one non-transitory memory having computer program code stored thereon that, in execution with the at least one processor, causes the apparatus to perform any one of the example computer-implemented methods described herein.

In another aspect, a computer program product for intelligent report configuration is provided. The example computer program product includes at least one non-transitory computer-readable storage medium having computer program code stored thereon that, in execution with at least one processor, configures the computer program product to perform any one of the example computer-implemented methods described herein.

### BRIEF DESCRIPTION OF THE SEVERAL VIEWS OF THE DRAWINGS

Having thus described the embodiments of the disclosure in general terms, reference now will be made to the accompanying drawings, which are not necessarily drawn to scale, and wherein:

FIG. 1 illustrates a block diagram of an example environment in which embodiments of the present disclosure may operate.

FIG. 2 illustrates a block diagram of an example apparatus in accordance with at least one example embodiment of the present disclosure.

FIG. 3 illustrates an example data flow diagram for intelligent report configuration in accordance with at least one example embodiment of the present disclosure.

FIG. 4A illustrates a visualization of report configuration user interface in accordance with at least one example embodiment of the present disclosure.

FIG. 4B illustrates an example chapter configuration user interface in accordance with at least one example embodiment of the present disclosure.

FIG. 4C illustrates an example user configuration user interface in accordance with at least one example embodiment of the present disclosure.

FIG. 4D illustrates an example chart configuration user interface in accordance with at least one example embodiment of the present disclosure.

FIG. 4E illustrates an example table configuration user interface in accordance with at least one example embodiment of the present disclosure.

FIG. 5 illustrates a flowchart depicting operations of an example process for intelligent report configuration in accordance with at least one example embodiment of the present disclosure.

### DETAILED DESCRIPTION

Embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based on in part on,” “based at least on,” “based upon,” and/or similar words are used herein interchangeably in an open-ended manner such that they do not indicate being based only on or based solely on the referenced element or elements unless so indicated. Like numbers refer to like elements throughout.

### Overview

In various contexts, enterprises such as businesses or other organizations may produce products of various types via various research, manufacturing, and/or distribution processes associated with production of these products. In many such cases, these enterprises may develop, implement, and/or utilize one or more systems (e.g., management system, process control systems, and/or the like), processes, and/or operations with respect to the research, manufacturing, and/or distribution processes for one or more purposes. For example, an enterprise may develop, implement, and/or utilize a quality management system to ensure product quality and/or ensure adherence to industry quality standards or regulations. In a medical context, for example, production of certain products (e.g., pharmaceutical products, medical equipment, and/or the like) may be subject to a relatively high degree of quality management standard and/or regulation. For example, Annual Product Quality Review (APQR) is a quality management process that is often required in connection with production of pharmaceutical products, during which various research, manufacturing, and/or distribution processes and any products resulting from said processes, are examined in detail to determine, for example, whether any changes to the products or processes are necessary. In some contexts, findings and/or results from the APQR process are compiled and presented in a quality report.

Various applications and/or systems may be utilized to implement and/or facilitate various functionalities of an enterprise's system. For example, a quality management software system may be utilized to implement and/or facilitate quality management and/or control measures undertaken by enterprises with respect to the production of their products. In some contexts, the system may be capable of facilitating and/or performing various functions including, for example, generating report(s) such as APQR reports. For example, the system may be configured to generate a report based on various sources of data accessible to the system and on interactions with and/or input (e.g., annotations) from various users associated with different portions (e.g., chapters) of the report. In various contexts, the system may be configured to generate each portion of the report based on the configuration for each portion of the report (e.g. based on configuration data that is leveraged by the system/application to determine the various portions of the report, retrieve the relevant data to generate the report, and/or relevant processes for generating a report). Notably, configuration often includes multiple steps to complete a given process, where a user navigates through multiple user interfaces to complete each step of the configuration process. Such complex and/or cumbersome user interface navigations often waste computing resources by forcing expenditure of computing resources multiple times (e.g., for each navigation), clogging up use of a system during the navigation between user interfaces, and forcing beginning of a subsequent process to await completion of each navigation to provide the relevant inputs utilized in the subsequent process. In various contexts, the configuration involves a manual process, where a user may be tasked with configuring each portion of the report. Such configuration may be a complex and tedious process, and may present a number of challenges.

For example, in one exemplary scenario mentioned for the purpose of illustration, a quality report for a particular product may comprise upwards of twenty different chapters, each of which may be assigned to a different user to provide input in parallel to complete configuration of the chapter. Moreover, an enterprise may produce several different products, each of which may be the subject of a different quality report. In a quality management system context, for example, a report may include multiple chapters, where each chapter may include multiple charts, multiple tables, multiple calculations, and/or the like, each embodying a sub-object associated with the chapter (e.g., a higher-level object). As a result, in such quality management system context, to generate a single report, a user may be required to configure multiple chapters as well as multiple charts, tables, calculations, and/or like for each chapter. As a result, it can be very difficult and inefficient with respect to computing expense for a user to navigate through multiple user interface to configure a report.

Embodiments of the present disclosure provide for intelligent report configuration recommendation to address at least the various problems and challenges describes above with respect to configuring a report, by for example, determining and providing configuration data for various portions of a report. In this regard, embodiments of the present disclosure may automatically configure various portions of a complex report, which obviates the need for a user to navigate through multiple user interfaces to complete the various configuration steps. Some embodiments, utilizing one or more models, generate one or more data objects indicative of configuration data for a configuration step (e.g., a configuration node) based at least in part on historical configuration data, historical reports, and/or real time data. Some embodiments, cause the one or more data objects to be displayed on one or more configuration user interfaces obviating the need for a user to navigate through multiple user interfaces to configure a report. Accordingly, by obviating the need for a user to navigate through multiple user interfaces, embodiments of the present disclosure reduces computing expense and network traffic. In this regard, embodiments of the present disclosure improve the functioning of computers and one or more technical fields, including at least the user interface technical field.

### Definitions

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The term “configuration data” refers to data that is used to control one or more values, for example data values, for one or more data parameters of a data object, and/or the behavior of a data object generated, maintained, or otherwise utilized by an application and/or system. For example, configuration data may comprise a collection of settings that influence the behavior of an application and/or a system. In some examples, configuration data is used to determine portions of a report to be generated. Alternatively or additionally, in some examples, configuration data is used to determine databases to retrieve data and/or the relevant data to retrieve from a database. “Historical configuration data” refers to configuration data previously received, detected, and/or stored associated with at least one previous timestamp.

The term “report” refers to a data entity that describes representation of data and/or analysis of data. For example, a report may include representation of data and/or analysis of data associated with one or more products produced by an enterprise. In some examples, a report may include multiple portions. For example, a report may include multiple chapters, where each chapter may include multiple charts, multiple tables, multiple calculations, and/or the like.

The terms “report configuration workflow,” “configuration workflow,” and “configuration process” each refers to a sequence of steps for configuring a report. In some examples, the configuration workflow comprises a plurality of configuration nodes. In some examples, the plurality of configuration nodes define a hierarchical structure or are otherwise arranged in a hierarchical fashion based at least in part on the hierarchical structure of the report to be generated.

The term “configuration node” refers to a portion of a configuration workflow for configuring a report. For example, each configuration node of a plurality of configuration nodes associated with a configuration workflow may correspond to a particular configuration step in the configuration workflow. A configuration node may be associated with a particular portion of the report to be generated. In some examples, a configuration node comprises one or more configuration input parameters.

The term “data object” refers to a data entity indicative of at least a portion of configuration data for a configuration node associated with a configuration workflow. A data object may represent values for one or more configuration input parameters associated with the configuration node.

The term “configuration user interface” refers to a user interface configured to receive configuration data for configuring a report. A configuration user interface may include one or more interface elements configured to receive configuration data. By way of example, a configuration user interface may include a graphical user interface.

The term “model” refers to a data entity that generates one or more outputs from one or more outputs based on one or more defined parameters, hyper-parameters, and/or defined operations. Non-limiting examples of a model include rules-based algorithm(s), statistical model(s), and/or machine learning model (e.g., model including at least one or more rule-based layers, one or more layers that depend on trained parameters, coefficients, and/or the like), and/or the like. In some examples, a model may be configured, trained, and/or the like to process historical configuration data, historical report, and/or real-time data in order to generate one or more data objects representing configuration data (or portion thereof) for one or more configuration nodes of a configuration workflow. The model may include one or more of any type of machine learning model including one or more supervised, unsupervised, semi-supervised, reinforcement learning models, and/or the like.

The term “product” refers to any item, article, substance, good, or otherwise any object. Non-limiting examples of a product include pharmaceutical drugs, automotive engines, and/or the like. In some examples, an enterprise may manufacture one or more products.

### Example Systems and Apparatuses of the Disclosure

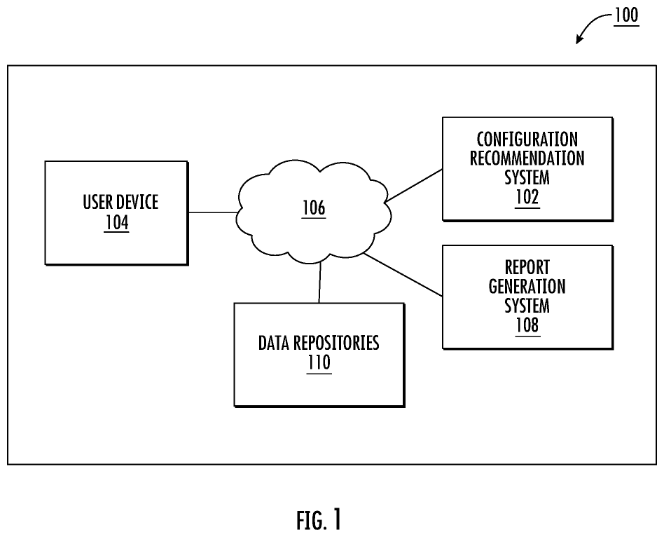

FIG. 1 illustrates a block diagram of an example environment 100 within which embodiments of the present disclosure may operate. Specifically, FIG. 1 illustrates an example configuration recommendation system 102, one or more user devices 104, report generation system 108, and one or more data repositories 110. One or more of the configuration recommendation system 102, one or more user devices 104, report generation system 108, and one or more data repositories 110 may communicate with each other over one or more communications network(s), for example a communications network 106.

It should be appreciated that the communications network 106 in some embodiments is embodied in any of a myriad of network configurations. In some embodiments, the communications network 106 embodies a public network (e.g., the Internet). In some embodiments, the communications network 106 embodies a private network (e.g., an internal localized, or closed-off network between particular devices). In some other embodiments, the communications network 106 embodies a hybrid network (e.g., a network enabling internal communications between particular connected devices and external communications with other devices). The communications network 106 in some embodiments includes one or more base station(s), relay(s), router(s), switch(es), cell tower(s), communications cable(s) and/or associated routing station(s), and/or the like. In some embodiments, the communications network 106 includes one or more user controlled computing device(s) (e.g., a user owned router and/or modem) and/or one or more external utility devices (e.g., Internet service provider communication tower(s) and/or other device(s)).

Each of the components of the environment 100 communicatively coupled to transmit data to and/or receive data from one another over the same or different wireless and/or wired networks embodying the communications network 106. Such configuration(s) include, without limitation, a wired or wireless Personal Area Network (PAN), Local Area Network (LAN), Metropolitan Area Network (MAN), Wide Area Network (WAN), and/or the like. Additionally, while FIG. 1 illustrate certain system entities as separate, standalone entities communicating over the communications network 106, the various embodiments are not limited to this architecture. In other embodiments, one or more computing entities share one or more components, hardware, and/or the like, or otherwise are embodied by a single computing device such that connection(s) between the computing entities over the communications network 106 are altered and/or rendered unnecessary. For example, in some embodiments, the one or more user devices 104 includes some or all of the configuration recommendation system 102, such that an external communications network 106 is not required.

In some embodiments, two or more of the configuration recommendation system 102, one or more user devices 104, report generation system 108, and one or more data repositories 110 are embodied in an on-premises system within or associated with an entity, for example, an enterprise. In such some embodiments, two or more of the configuration recommendation system 102, one or more user devices 104, report generation system 108, and one or more data repositories 110 may be communicatively coupled via at least one wired connection. Alternatively or additionally, in some embodiments, the one or more user devices 104 embodies or includes one or more of the configuration recommendation system 102, one or more user devices 104, report generation system 108, and one or more data repositories 110, for example as a software component of a single enterprise terminal. Alternatively or additionally, in some embodiments, the report generation system 108 includes the configuration recommendation system 102.

In some embodiments, the one or more data repositories 110 may be configured to receive, store, and/or transmit data. In some embodiments, the one or more data repositories 110 may be configured to store data associated with generating and/or presenting configuration data (e.g., by the configuration recommendation system 102) for configuring report(s), including, for example, historical report(s), historical configuration data, and/or data relevant for recommending configuration data. In some embodiments, some or all of the data stored in the one or more data repositories 110 may be stored in a shared memory system shared between the configuration recommendation system 102 and/or report generation system 108, and/or may be otherwise accessible to configuration recommendation system 102 and/or report generation system 108. In some embodiments, some or all of the data stored in the one or more data repositories 110 may be stored in different memory system with respect to the configuration recommendation system 102 and the report generation system 108.

The one or more user devices 104 may be associated with and/or operated by users of the report generation system 108, configuration recommendation system 102, and/or one or more operational systems associated with the one or more products and/or production of the one or more products. In some embodiments, the operational system(s) may be caused to transmit data associated with the production of the one or more products and/or that may be used to generate data and/or visualization objects for a report in accordance with configuration data presented on one or more configuration user interfaces displayed on the user device(s) 104, which configuration user interface(s) may be configured to receive the configuration data. The configuration recommendation system 102 in some embodiments may cause configuration data associated with configuring report(s) to be transmitted to, to be displayed on, and/or to be used to generate data or interface elements displayed on the user device(s) 104 and/or may cause one or more configuration user interfaces to be presented via the user device(s) 104. The report generation system 108 in some embodiments may cause data associated with generation of reports with respect to the one or more products to be transmitted to, to be displayed on, and/or to be used to generate data or interface elements displayed on the user device(s) 104 and/or may cause one or more interfaces (e.g., user interfaces) to be presented via the user device(s) 104, which interface(s) may be configured to receive input comprising and/or used to generate any data associated with generation of the reports.

The configuration recommendation system 102 may include any number of computing device(s) and/or system(s) (e.g., server system) configured, for example, via hardware, software, firmware, and/or a combination thereof, to facilitate and/or perform various functionalities associated with configurating report(s). For example, in some embodiments, the configuration recommendation system 102 may include any number of computing device(s) and/or system(s) configured for presenting at least a portion of configuration data for configuring a report(s) on one more configuration user interfaces. In some embodiments, the configuration recommendation system 102 may be configured to generate the configuration data based on historical configuration data, historical report(s), and/or real-time data associated with generation of report(s). In some embodiments, the configuration recommendation system 102 may include any number of computing device(s) and/or system(s) configured for identifying, retrieving, receiving, and/or storing one or more historical reports in the one or more data repositories, for example, one or more repositories 110). In some embodiments, the configuration recommendation system 102 may include any number of computing device(s) and/or system(s) configured for identifying, extracting, and/or parsing historical configuration data associated with one or more historical reports. In some embodiments, the configuration recommendation system 102 may include any number of computing device(s) and/or system(s) configured for accessing, analyzing, parsing, and/or retrieving historical configuration data and/or historical reports stored in the one or more data repositories 110. In some embodiments, the configuration recommendation system 102 may include any number of computing device(s) and/or system(s) configured for assembling and/or grouping historical configuration data into a plurality of groups representing, where each group may be associated with one or more configuration level of hierarchical configuration workflow for configuring report(s).

In some embodiments, the report generation system 108 may include any device(s) and/or computing system(s) (e.g., server system) configured for example, via hardware, software, firmware, and/or a combination thereof, to facilitate and/or perform various functionalities associated with generating report(s). For example, in some embodiments, the report generation system 108 may include any device(s) and/or computing system(s) configured for presenting user interface(s) configured to receive data used in generating report(s) and/or configured for presenting user interface(s) configured to display data associated with a report (e.g., report data). In some embodiments, the report generation system 108 may include any device(s) and/or computing system(s) configured for receiving (e.g., via the presented user interface(s)), accessing, and/or retrieving configuration data (e.g., generated by the configuration recommendation system 102). In some embodiments, the report generation system 108 may include any device(s) and/or computing system(s) configured for receiving (e.g., via the presented user interface(s) and/or from the one or more data repositories 110), accessing, and/or retrieving relevant data for generating report(s) based at least in part on configuration data for the respective report, where the configuration recommendation system 102 may be configured to generate and/or present at least a portion of the configuration data for the respective report. For example, the report generation system 108 may be configured to generate a report for discrete portions (e.g., chapters, sub-chapters, sections, and/or the like) of the report(s) based at least in part on the configuration data for the respective discrete portion.

In some embodiments, the configuration recommendation system 102 and the report generation system 108 may have varying degrees of integration with respect to each other. For example, the configuration recommendation system 102 and the report generation system 108 may be configured to transmit and/or receive communications and/or data with respect to each other and/or access commonly accessible or shared data repositories to exchange configuration data and/or other data. In another example, the configuration recommendation system 102 may be a sub-system of and/or otherwise integrated as part of the report generation system 108. In another example, the configuration recommendation system 102 and the report generation system 108 may be sub-systems of and/or otherwise integrated as part of a greater system (e.g., in a quality report generation context, a greater quality management software system configured to perform one or more quality management operations with respect to one or more products produced by one or more enterprises and/or one or more processes and/or systems associated with production of the one or more products). While FIG. 1 illustrates certain components as separate, standalone entities communicating over the network 106, various embodiments are not limited to this configuration. In other embodiments, one or more components may be directly connected and/or share hardware or the like.

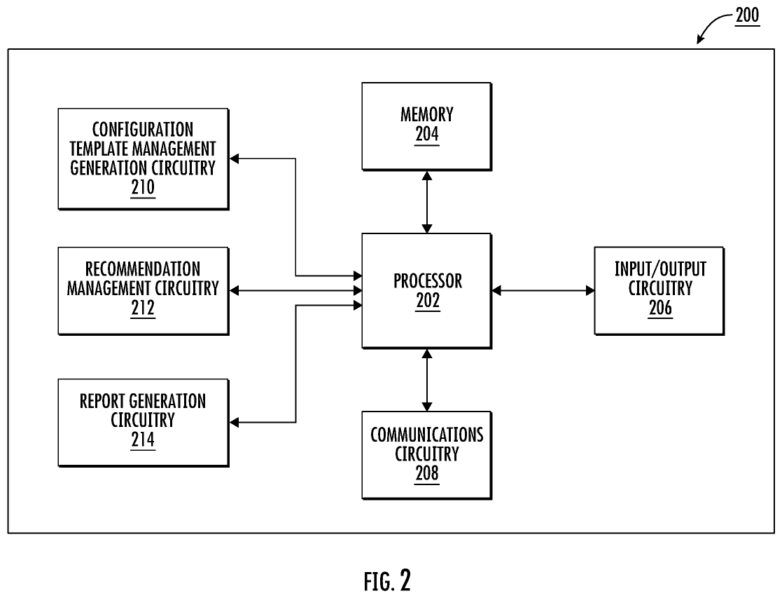

FIG. 2 illustrates a block diagram of an example apparatus in accordance with at least one example embodiment of the present disclosure. Specifically, FIG. 2 depicts an example apparatus 200 (“apparatus 200”) specially configured in accordance with at least some example embodiments of the present disclosure. In some embodiments, the configuration recommendation system 102 and/or a portion thereof is embodied by one or more system(s), such as the apparatus 200 as depicted and described in FIG. 2. The apparatus 200 includes processor 202, memory 204, input/output circuitry 206, communications circuitry 208, configuration template management circuitry 210, recommendation management circuitry 212, and/or report generation circuitry 214. In some embodiments, the apparatus 200 is configured, using one or more of the sets of circuitry embodied by processor 202, memory 204, input/output circuitry 206, communications circuitry 208, configuration template management circuitry 210, recommendation management circuitry 212, and/or report generation circuitry 214, to execute and perform the operations described herein.

In general, the terms computing entity (or “entity” in reference other than to a user), device, system, and/or similar words used herein interchangeably may refer to, for example, one or more computers, computing entities, desktop computers, mobile phones, tablets, phablets, notebooks, laptops, distributed systems, products/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably. In this regard, the apparatus 200 embodies a particular, specially configured computing entity transformed to enable the specific operations described herein and provide the specific advantages associated therewith, as described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), network interface(s), storage medium(s), and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively or additionally, in some embodiments, other elements of the apparatus 200 provide or supplement the functionality of another particular set of circuitry. For example, the processor 202 in some embodiments provides processing functionality to any of the sets of circuitry, the memory 204 provides storage functionality to any of the sets of circuitry, the communications circuitry 208 provides network interface functionality to any of the sets of circuitry, and/or the like.

In some embodiments, the processor 202 (and/or co-processor or any other processing circuitry assisting or otherwise associated with the processor) is/are in communication with the memory 204 via a bus for passing information among components of the apparatus 200. In some embodiments, for example, the memory 204 is non-transitory and may include, for example, one or more volatile and/or non-volatile memories. In other words, for example, the memory 204 in some embodiments includes or embodies an electronic storage device (e.g., a computer readable storage medium). In some embodiments, the memory 204 is configured to store information, data, content, applications, instructions, or the like, for enabling the apparatus 200 to carry out various functions in accordance with example embodiments of the present disclosure.

The processor 202 may be embodied in a number of different ways. For example, in some example embodiments, the processor 202 includes one or more processing devices configured to perform independently. Additionally or alternatively, in some embodiments, the processor 202 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the apparatus 200, and/or one or more remote or “cloud” processor(s) external to the apparatus 200.

In an example embodiment, the processor 202 is configured to execute instructions stored in the memory 204 or otherwise accessible to the processor. Alternatively or additionally, the processor 202 in some embodiments is configured to execute hard-coded functionality. As such, whether configured by hardware or software methods, or by a combination thereof, the processor 202 represents an entity (e.g., physically embodied in circuitry) capable of performing operations according to an embodiment of the present disclosure while configured accordingly. Alternatively or additionally, as another example in some example embodiments, when the processor 202 is embodied as an executor of software instructions, the instructions specifically configure the processor 202 to perform the algorithms embodied in the specific operations described herein when such instructions are executed. In some embodiments, the processor 202 includes hardware, software, firmware, and/or a combination thereof that performs one or more operations described herein.

As one particular example embodiment, the processor 202 is configured to perform various operations associated with generating configuration data associated with generating a report, such as a report comprising multiple chapters, presenting configuration data associated with generating a report (e.g., via configuration user interface(s)), and/or generating report(s).

In some embodiments, the apparatus 200 includes input/output circuitry 206 that provides output to the user and, in some embodiments, to receive an indication of a user input. In some embodiments, the input/output circuitry 206 is in communication with the processor 202 to provide such functionality. The input/output circuitry 206 may comprise one or more user interface(s) and in some embodiments includes a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a user device and/or other display associated with a user.

In some embodiments, the apparatus 200 includes communications circuitry 208. The communications circuitry 208 includes any means such as a device or circuitry embodied in either hardware or a combination of hardware and software that is configured to receive and/or transmit data from/to a network and/or any other device, circuitry, or module in communication with the apparatus 200. In this regard, in some embodiments the communications circuitry 208 includes, for example, a network interface for enabling communications with a wired or wireless communications network. Additionally or alternatively in some embodiments, the communications circuitry 208 includes one or more network interface card(s), antenna(s), bus(es), switch(es), router(s), modem(s), and supporting hardware, firmware, and/or software, or any other device suitable for enabling communications via one or more communications network(s). Additionally or alternatively, the communications circuitry 208 includes circuitry for interacting with the antenna(s) and/or other hardware or software to cause transmission of signals via the antenna(s) or to handle receipt of signals received via the antenna(s). In some embodiments, the communications circuitry 208 enables transmission to and/or receipt of data from user device, one or more asset(s) or accompanying sensor(s), and/or other external computing device in communication with the apparatus 200.

In some embodiments, the apparatus 200 includes configuration template management circuitry 210. The configuration template management circuitry 210 may include hardware, software, firmware, and/or a combination thereof, configured to request, receive, process, generate, and transmit data, data structures, control signals, and electronic information for extracting, collecting, assembling and/or aggregating historical configuration data and/or historical report(s), including performing any of the operations described herein with respect to generation of configuration data for one or more portions of a configuration workflow for configuring report(s). In some embodiments, the configuration template management circuitry 210 includes a separate processor, specially configured field programmable gate array (FPGA), or a specially programmed application specific integrated circuit (ASIC).

In some embodiments, the apparatus 200 includes recommendation management circuitry 212. The recommendation management circuitry 212 may include hardware, software, firmware, and/or a combination thereof, configured to request, receive, process, generate, and transmit data, data structures, control signals, and electronic information for generating and/or presenting at least a portion of the configuration data for one or more portions of a configuration workflow for configuring report(s), including performing any of the operations described herein with respect to generating and/or presenting configuration data. In some embodiments, the recommendation management circuitry 212 includes a separate processor, specially configured field programmable gate array (FPGA), or a specially programmed application specific integrated circuit (ASIC).

In some embodiments, the apparatus 200 includes report generation circuitry 214. The report generation circuity 214 may include hardware, software, firmware, and/or a combination thereof, configured to request, receive, process, generate, and transmit data, data structures, control signals, and electronic information for generating report(s), including performing any of the operations described herein with respect to generation of report(s). In some embodiments, the report generation circuitry 214 includes a separate processor, specially configured field programmable gate array (FPGA), or a specially programmed application specific integrated circuit (ASIC).

In some embodiments, two or more of the sets of circuitries embodying processor 202, memory 204, input/output circuitry 206, communications circuitry 208, configuration template management circuitry 210, recommendation management circuitry 212, and/or report generation circuitry 214. Alternatively or additionally, in some embodiments, one or more of the sets of circuitry perform some or all of the functionality described associated with another component. For example, in some embodiments, two or more of the sets of circuitry embodied by processor 202, memory 204, input/output circuitry 206, communications circuitry 208, configuration template management circuitry 210, recommendation management circuitry 212, and/or report generation circuitry 214, are combined into a single module embodied in hardware, software, firmware, and/or a combination thereof. Similarly, in some embodiments, one or more of the sets of circuitry, for example configuration template management circuitry 210, recommendation management circuitry 212, and/or report generation circuitry 214, is/are combined with the processor 202, such that the processor 202 performs one or more of the operations described above with respect to each of these sets of circuitry embodied by the configuration template management circuitry 210, recommendation management circuitry 212, and/or report generation circuitry 214.

### Example Data Flows of the Disclosure

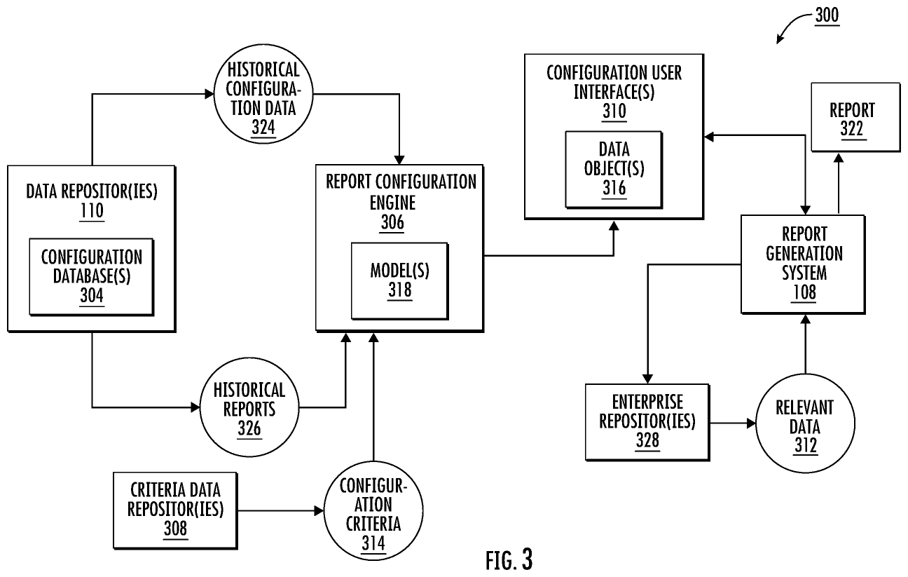

Having described example apparatuses and systems in accordance with the disclosure, example data flows in accordance with the disclosure will now be described. The data flow(s) describe assembling of historical configuration data, generation of configuration data, and/or generation of report(s) associated with one or more products. In some embodiments, the data flow includes operations performed by computing system(s) embodying individual system(s), device(s), apparatus(es), and/or the like, and data transmissions between such computing system(s). In some embodiments, the data transmission(s) are facilitated via one or more communications network(s) connecting such computing device(s). Specifically, FIG. 3 illustrates an example data flow diagram for intelligent report configuration in accordance with at least one example embodiment of the present disclosure. FIG. 3 includes schematic depictions of an example configuration recommendation system 102, including example internal processes and components of the configuration recommendation system 102, and/or schematic depictions of the one or more data repositories 110 and/or the report generation system 108 in communication with the configuration recommendation system 102, along with example data object(s) used by and/or generated by the depicted processes, components, and/or systems. The configuration recommendation system 102 and/or apparatuses 200 associated therewith, for example, may be specially configured via hardware, software, firmware, and/or a combination thereof, to perform the various data processing and interactions described with respect to FIG. 3 to perform configuration recommendation with respect to generation of report(s) for one or more products produced by one or more enterprises.

In the illustrated embodiment, the configuration recommendation system 102 comprises, a report configuration engine 306, one or more configuration user interface 310, and/or one or more data repositories 110. In some embodiments, the report configuration engine 306 is configured to generate one or more data objects 316 representing at least a portion of the configuration data for one or more portions of a configuration workflow for configuring reports (e.g., by the report generation system 108). The configuration workflow in some embodiments comprises a plurality of configuration nodes corresponding to the steps associated with configuring a report based at least in part on the configuration workflow. For example, each configuration node may correspond to a particular configuration step in the configuration workflow. In some embodiments, the configuration nodes define a hierarchical structure or are otherwise arranged in a hierarchical fashion based at least in part on the hierarchical structure of the report. For example, a report may comprise multiple portions, where each portion may comprise one or more parts associated with the particular portion of the report. For example, a report may comprise a plurality of chapters, where each chapter may comprise one or more users assigned to the respective chapter, and/or where each chapter may comprise one or more charts and/or one or more tables. As another example, a report may comprise a plurality of chapters, where each chapter may comprise one or more sub-chapters, and each sub-chapter may comprise one or more charts and/or one or more tables. In this regard, in some embodiments, the configuration workflow comprises or otherwise defines a hierarchical structure comprising a plurality of configuration nodes having parent-child relationships.

In some embodiments, each layer of the hierarchical structure of the configuration workflow is associated with one or more configuration classes of a plurality of configuration classes. For example, one or more layers of the hierarchical structure may comprise one or more configuration nodes belonging to the same configuration class. Alternatively or additionally, for example, one or more layers of the hierarchical structure may comprise at least two configuration nodes associated with different configuration classes with respect to each other. Non-limiting examples of a configuration class include report configuration class, chapter configuration class, user configuration class, chart configuration class, sub-chapter configuration class, section configuration class, table configuration class, calculation configuration class, and/or the like.

In some embodiments, for example, the configuration workflow comprises at least one or more report configuration node(s), chapter configuration node(s), user configuration node(s), chapter configuration node(s) and/or table configuration node(s) having parent-child relationships. In some embodiments, a configuration workflow may comprise at least one report configuration node associated with one or more or more chapter configuration nodes based on a parent-child relationship, where the report configuration node corresponds to a parent node in the hierarchical structure of the configuration workflow, and each of the one or more chapter configuration nodes correspond to a respect child node of the parent node (e.g., representing the report configuration node). Alternatively or additionally, in some embodiments, the configuration workflow comprises one or more chapter configuration nodes that are each associated with one or more user configuration nodes based on a parent-child relationship, where each user configuration node for a given chapter configuration node corresponds to a child node (e.g., in the hierarchical structure of the configuration workflow) with respect to the associated chapter configuration node, where the associated chapter configuration node corresponds to a parent node with respect to the user configuration node(s). Alternatively or additionally, in some embodiments, the configuration workflow comprises one or more chapter configuration nodes that are each associated with one or more chart configuration nodes based on a parent-child relationship, where each chart configuration node for a given chapter configuration node corresponds to a child node (e.g., in the hierarchical structure of the configuration workflow) with respect to the associated chapter configuration, where the associated chapter configuration node corresponds to a parent node with respect to the table configuration node(s). Alternatively or additionally, in some embodiments, the configuration workflow comprises one or more chapter configuration nodes that are each associated with one or more table configuration nodes based on a parent-child relationship, where each table configuration node for a given chapter configuration node corresponds to a child node (e.g., in the hierarchical structure of the configuration workflow) with respect to the associated chapter configuration node, where the associated chapter configuration node corresponds to a parent node with respect to the table configuration node(s).

In some embodiments, the report configuration engine 306 is configured to generate one or more data objects 316 representing at least a portion of the configuration data for one or more configuration nodes of the configuration workflow. In some embodiments, a configuration node comprises one or more configuration input parameters, where the configuration data for a particular configuration node comprises one or more data objects 316 representing values for the one or more configuration input parameters associated with the particular configuration node. A report configuration node (e.g., associated with a report configuration class), for example, may comprise one or more report configuration input parameters configured for defining and/or identifying one or more products and/or report to be generated (e.g., by the report generation system 108) for the one or more products. In some embodiments, examples of such report configuration input parameters include product name, product description, report type, report configuration type, and/or other input parameters determined to be relevant for defining and/or identifying product(s) and/or report to be generated for the product(s). The report configuration input parameters for a report, for example, may inform the selection and/or arrangements of the portions of the report.

A chapter configuration node (e.g., associated with a chapter configuration class), for example, may comprise one or more chapter configuration input parameters configured for defining and/or identifying chapters for the report 322. In some embodiments, examples of such chapter configuration input parameters include chapter name, domain name, and/or other input parameters determined to be relevant for defining and/or identifying the chapters for the report 322. In a quality report generation context, for example, chapter name may include “Executive Summary,” “Critical In-process Control,” “Quality and Yield Review,” “Change Control” and/or the like. In such quality report generation context, for example, one or more chapters may correspond to a particular portion of a quality management system. In some embodiments, the particular chapter configuration input parameters associated with a chapter configuration node may be dependent on the report selected or otherwise defined at the report configuration node.

A user configuration node (e.g., associated with a user configuration class), for example, may comprise one or more user configuration input parameters configured for defining and/or identifying one or more users for a particular chapter selected or otherwise defined for the report 322 at the corresponding chapter configuration node. In some embodiments, examples of such user configuration input parameters include username, user role, user identification, and/or other input parameters determined to be relevant for defining and/or identifying a user, a user account, a user profile, a user role, and/or the like for a chapter of the report 322. For example, a user may be assigned to a particular chapter of the report 322 to review, modify, update, and/or approve the configuration data and/or report data for the chapter.

A chart configuration node (e.g., associated with a chart configuration class), for example, may comprise one or more chart configuration input parameters configured for defining and/or generating one or more charts for a particular chapter selected or otherwise defined for the report 322 at the corresponding chapter configuration node. In some embodiments, examples of such chart configuration input parameters include data source name(s) identifying one or more data sources for retrieving relevant data (e.g., e.g., a portion of enterprise data 302) for generating the one or more chart(s) for the particular chapter, object name (e.g., QMSData, LIMSData, and/or the like), column name (e.g., id, type, and/or the like), aggregation type (e.g., sum, count, and/or the like), and/or other chart configuration input parameters determined to be relevant for defining and/or generating desired chart(s) for the particular chapter of the report 322.

A table configuration node (e.g., associated with a table configuration class, for example, may comprise one or more table configuration input parameters configured for defining and/or generating one or more tables for a particular chapter for the report 322. In some embodiments, examples of such table configuration input parameters include data source name(s) identifying one or more data source(s) for retrieving relevant data (e.g., a portion of enterprise data 302) for generating one or more tables(s) for the particular chapter, object name (e.g., QMSData, LIMSData, and/or the like), column name (e.g., id, type, and/or the like), aggregation type (e.g., sum, count, and/or the like), and/or other parameters relevant for defining and/or generating desired table(s) for the particular chapter of the report 322.

It should be understood that the above examples are not intended to be limiting. For example, in some contexts, a configuration workflow may include additional configuration nodes and/or additional configuration classes, and/or may not include one or more of the example configuration nodes and/or configuration classes described above.

In some embodiments, one or more portions (e.g., chapters, sub-chapters, sections, and/or the like) of the report 322 may correspond to an aspect of an operational system associated with a product with respect to which the report 322 is to be generated. In some examples, an operational system(s) may describe a system that is configured to monitor, implement, control, and/or facilitate various research, manufacturing, testing, distribution, quality management, and/or business processes associated with production of the product(s). The operational system(s), in some examples, may include various components, including, in some examples, controllers, sensors, actuators, laboratory devices, tools, manufacturing devices, distribution devices, computing devices (or any combination thereof) configured to perform some or all of the functionality involved in the monitoring, implementing, controlling, and/or facilitating of the various processes. The operational system(s) may be configured, in some examples, to monitor and/or control various physical aspects of the process(es) and/or associated environments. In some examples, the operational system(s) may include computer, software, and/or network systems associated with the production of the product(s), including one or more enterprise networks (e.g., comprising user devices, server devices, and/or networking devices connected to each other via one or more networks), one or more cloud-based or on-site, centralized and/or distributed software systems, content management systems, knowledge management systems, project management systems, customer relationship management systems, human resources management systems, and/or any systems associated with internal and/or external processes and/or operations related to the production of the product(s). In some examples, the operational system(s), and/or any system(s) or device(s) configured to monitor, control, and/or communicate with the operational system(s), may generate various types of data resulting from and/or characterizing operation of these system(s), and such data may be captured, collected, and/or aggregated as part of enterprise data 302. In some embodiments, the enterprise data 302 (or a portion of the enterprise data 302 may be stored in the one or more data repositories 110 Alternatively and/or additionally, in some embodiments, the enterprise data 302 (or a portion of the enterprise data 302 may be stored in one or more data repositories separate from the one or more data repositories 110, for example, one or more enterprise data repositories 328.

In some embodiments, the enterprise data 302 may comprise data associated with and/or generated during or in connection with any phase of production of the product(s) and/or any corresponding process(es), including any research, manufacturing, testing, distribution, quality management, and/or business phases or processes. In some embodiments, the enterprise data 302 may include external data accessed, retrieved, collected, and/or received from one or more external sources of data, the external data being associated with and/or related to the product(s) and/or various process(es) associated with the product(s). For example, external data of the enterprise data 302 may comprise data retrieved from archives, databases, research indexes, and/or data sets publicly available, including, for example, data identifying and/or characterizing quality management specifications related to the product(s) and/or various process(es) associated with production of the product(s).

In some embodiments, the one or more data repositories 110 comprise one or more configuration databases 304, for example, one or more standard query language (SQL) databases, and/or other database types. In some embodiments, the one or more configuration databases 304 includes historical configuration data associated with one or more historical reports generated by the report generation system 108 and/or other system(s). In such some embodiments, configuration recommendation system 102 may be configured to process the one or more historical reports to extract, retrieve, collect, and/or aggregate configuration data (e.g., historical configuration data) leveraged in generating the one or more historical reports. In some embodiments, the historical configuration data includes metadata associated with the configuration of the historical reports and/or generation of the historical reports. For example, the historical configuration data may include timestamp data indicative of when a given historical report was configured and/or generated; site data describing the site associated with a given historical report, product identification describing the product associated with a given historical configuration data and/or historical report; duration to complete review of a particular chapter (e.g., “Executive Summary” chapter “Critical In-process Control” chapter, “Quality and Yield Review” chapter, “Change Control” chapter and/or the like in a quality report generation context) by a particular user, and/or the like.

The configuration recommendation system 102 may store the historical configuration data associated with the one or more historical reports in the one or more configuration databases 304. In some embodiments, the configuration recommendation system 102 may be configured to group the historical configuration data into categories, for example, based on configuration class and/or other criteria. The configuration recommendation system 102 may be configured to store the historical configuration data 324 based on the categories. For example, in some embodiments, the configuration databases 304 may comprise one or more databases, where each database is associated with one or more configuration classes. For example, a first database may comprise historical report configuration data aggregated from or otherwise associated with one or more historical reports, a second database may comprise historical chapter configuration data aggregated from or otherwise associated with one or more historical reports, a third database may comprise one or more historical chart configuration data aggregated from or otherwise associated with one or more historical reports, a fourth database may comprise one or more historical table configuration data aggregated from or otherwise associated with one or more historical reports, a fifth database may comprise one or more historical user configuration data aggregated from or otherwise associated with one or more historical reports, and/or the like. In some embodiments, the configuration recommendation system 102 may store the configuration data in different partitions of a single database based at least in part on the configuration class. Alternatively or additionally, in some embodiments, the one or more data repositories 110 may comprise one or more historical reports themselves (e.g., including the one or more historical reports from which the historical configuration data were extracted and/or different historical reports.). For example, the configuration recommendation system may be configured to extract, retrieve, receive, collect, and/or aggregate one or more historical reports and store the one or more historical reports in the one or more data repositories 110.

In some embodiments, the configuration recommendation system 102 may be configured to update the one or more data repositories 110. For example, the configuration recommendation system 102 may be configured to store each final report generated by the report generation system 108 or received from another system in the one or more data repositories 110. Alternatively or additionally, for example, the configuration recommendation system 102 may be configured to extract, retrieve, collect, and/or aggregate historical configuration data associated with each final report (e.g., generated by the report generation system 108 and/or received from a different system) and store in the one or more data repositories 110.

As described above, in some embodiments, the report configuration engine 306 may be configured to generate and/or present data object(s) 316 representing at least a portion of configuration data for one or more configuration nodes of a configuration workflow having, for example, a hierarchical structure. For example, the report configuration engine 306 may be configured to generate and/or present one or more data objects 316 for one or more configuration input parameters (e.g., report configuration input parameter(s), chapter configuration input parameter(s), user configuration input parameter(s), chart configuration input parameter(s), table configuration input parameter(s), and/or the like) associated with a configuration node. In some embodiments, the report configuration engine 306 may be configured to generate and/or present data object(s) 316 in response to receiving a signal indicative of a configuration request for a report. In some embodiments, the signal is received from the user device. In some embodiments, the signal may be generated in response to user interaction with a user interface associated with report configuration and/or report generation. For example, the signal may be generated in response to user interaction with a configuration user interface 310.

In some embodiments, the report configuration engine 306 may be configured to generate and/or present the data objects 316 based at least in part on the historical configuration data 324, historical reports 326, and/or real-time data. In this regard, in some embodiments, the configuration recommendation system 102 may be configured to perform configuration (e.g., partial configuration or complete configuration) for one or more portions of the report 322 based at least in part on historical configuration data 324, historical reports 326, and/or real-time data, including, for example, presenting the one or more data objects 316 within one or more configuration user interfaces 310. The one or more configuration user interfaces 310 may comprise one or more interface elements (e.g., interactable element, graphical elements, and/or the like) configured to receive data object(s), and each of the one or more configuration user interfaces 310 may be associated with a particular configuration node of the configuration workflow. For example, a given configuration user interface 310 may comprise one or more interface elements corresponding to one or more configuration input parameters for the configuration node associated with the given configuration user interface 310. In this regard, the one or more interface elements of a given configuration user interface 310 may be configured to receive one or more data objects representing the value(s) for the one or more configuration input parameters for the configuration node associated with the given configuration user interface 310.

In this regard, in some embodiments, the configuration recommendation system 102 may be configured to perform configuration recommendation for one or more portions of a report, including generating and populating one or more user interface elements of a configuration user interface with one or more data objects determined based at least in part on historical configuration data 324, historical report 326, and/or real-time data. In some embodiments, performing configuration of one or more portions of a report may include generating the one or more configuration user interfaces 310, for example, based at least in part on the historical configuration data 324, historical report 326, and/or real-time data. In such some embodiments, the configuration recommendation system 102 may be configured to present the one or more configuration user interfaces 310 on one or more displays of the user device(s) 104.

In some embodiments, the configuration recommendation system 102 may leverage one or more models 318 to generate the data object(s) 316 for a configuration node. In some embodiments, a model may refer to a data entity that generates one or more outputs from one or more outputs based on one or more defined parameters, hyper-parameters, and/or defined operations. Non-limiting examples of a model include rules-based algorithm(s), statistical model(s), and/or machine learning model (e.g., model including at least one or more rule-based layers, one or more layers that depend on trained parameters, coefficients, and/or the like), and/or the like.

In some examples, a model may be configured, trained, and/or the like to process historical configuration data, historical report, and/or real-time data in order to generate one or more data objects representing configuration data (or portion thereof) for one or more configuration nodes of a configuration workflow. The model may include one or more of any type of machine learning model including one or more supervised, unsupervised, semi-supervised, reinforcement learning models, and/or the like.

In some embodiments, each configuration class may be associated with a particular model. For example, in some embodiments, a particular model may be configured, trained, and/or the like to process historical configuration data, historical report(s), and/or real-time data to generate one or more data objects for configuration node(s) associated with a particular configuration class. In some embodiments, a particular model may be configured, trained, and/or the like to process historical configuration data, historical report(s), and/or real-time data to generate configuration data for user configuration node(s). As another example, a particular model may be configured, trained, and/or the like to process historical configuration data, historical report(s), and/or real-time data to generate configuration data for table configuration node(s). As yet another example, a given model may be configured, trained, and/or the like to process historical configuration data, historical report(s), and/or real-time data to generate configuration data for chart configuration node(s). In some examples, the model may include multiple models configured to perform one or more different stages of a prediction process. For example the model may include a first model configured, trained, and/or the like to process historical configuration data, historical report(s), and/or real-time data to generate configuration data for a report configuration node; a second model configured, trained, and/or the like to process historical configuration data, historical report(s), and/or real-time data to generate configuration data for a user configuration node, a third model configured, trained, and/or the like to process historical configuration data, historical report(s), and/or real-time data to generate configuration data for a table configuration node; a fourth model configured, trained, and/or the like to process historical configuration data, historical report(s), and/or real-time data to generate configuration data for a chart configuration node; and/or the like.

In some embodiments, the one or more models may be associated with a particular enterprise. In some embodiments, the one or more models (or a portion thereof) may be associated with a plurality of enterprises having shared characteristic(s), for example, the same industry, the same product types, and/or the like. In such some embodiments, the one or more models (or portion thereof) may be trained on training data associated with the plurality of enterprises.

In some embodiments, at least one model may be configured, trained, and/or the like to process at least a portion of the historical configuration data 324, historical report 326, and/or real-time data to identify patterns and/or similarities between historical configuration data for one or more products. For example, the configuration recommendation system 102, using the noted at least one model, may be configured to generate and/or present data object(s) representing assignment of a particular user to a particular chapter of the report 322 being configured based at least in part on determining that the particular user has previously been assigned to the particular chapter for a plurality of historical reports associated with the same product or different products.

In some embodiments, at least one model may be configured, trained, and/or the like to process at least a portion of the historical configuration data 324, historical report 326, and/or real-time data to determine the work load and/or available bandwidth for one or more candidate users for a particular chapter (e.g., users that may be assigned to a particular chapter, for example, based on the department associated with the particular chapter). For example, the configuration recommendation system 102, using the noted at least one model, may be configured to generate and/or present data object(s) representing assignment of a particular user to a particular chapter of the report 322 being configured based at least in part on the workload and/or available bandwidth for each of one or more candidate users. In this regard, the configuration recommendation system 102, using the noted at least one model may be configured to auto load balance user assignments across one or more report(s) to be generated and/or across pending generated reports (e.g., reports under review). For example, the at least one model may be configured to parse and/or analyze one or more pending generated reports and/or report(s) to be generated in order to determine the workload and/or available bandwidth for each of one or more candidate users. The configuration recommendation system 102 may generate and/or present data object(s) representing user assignment for a particular user configuration node associated with configuring the report 322 based at least in part on the determined workload and/or available bandwidth for the one or more candidate users. To provide context, the candidate user may comprise team members of a particular department associated with the particular chapter. Alternatively and/or additionally, at least one model may be configured to generate data object(s) representing user assignment for a particular chapter based at least in part on the duration to complete review of the particular chapter and/or complete other tasks associated with approval of the particular chapter.

In some embodiments, at least one model may be configured, trained, and/or the like to perform one or more trend analysis operations to generate and/or present data object(s) for one or more configuration nodes. For example, the noted at least one model may be configured to perform one more trend analysis operations (e.g., including analyzing historical probabilities) with respect to database names, column names, calculation types, table names, and/or the like based on the historical configuration data 324, historical reports 326, and/or real-time data. The at least one model, based at least in part on the one or more trend analysis operations, may generate and/or present data object(s) representing configuration data (e.g., database name, column name, calculation type, table name, and/or the like) for a table configuration node associated with configuring a report, such as report 322. As another example, at least one model may be configured, trained, and/or the like to perform one more trend analysis operations (e.g., including analyzing historical probabilities) with respect to database names, coordinates (e.g., x-axis, y-axis, and/or the like), calculation types, chart names, and/or the like based on the historical configuration data 324, historical reports 326, and/or real-time data. The at least one model, based at least in part on the one or more trend analysis operations, may generate and/or present data object(s) representing configuration data (e.g., database name, column name, calculation type, table name, and/or the like) for a chart configuration node associated with configuring a report, such as the report 322. It should be appreciated that the above example models are not intended to be limiting.

Alternatively or additionally, in some embodiments, the configuration recommendation system 102 may be configured to generate the configuration data based at least in part on predefined (and/or user-configurable) configuration criteria 314. In some embodiments, the configuration criteria may be stored in the one or more data repositories 110. In some embodiments, the configuration criteria may be stored in one or more data repositories separated from the one or more data repositories. For example, the configuration criteria may be stored in one or more criteria data repositories 308. In some embodiments, the criteria 314 may comprise one or more rules. For example, in some embodiments, the configuration recommendation system 102 may be configured to apply one or more rules with respect to processing historical configuration data, historical reports, and/or real-time data to generate data object(s) representing configuration data for a configuration node of a configuration workflow. By way of example, the one or more rules may be based on a particular product. Alternatively or additionally, by way of example, the one or more rules may include expected probability of a chart, a table, and/or the like being configured to be of specific type; expected probability of including specific input parameters; expected probability of including specific labels; expected probability of including legend(s), and/or the like. The one or more rules, for example, may be based on historical data indicative of the history of running reports on the same product, by the same user, and/or by the same enterprise. In some embodiments, the one or more rules may be enterprise-specific. For example, the one or more rules may include domain knowledge associated with the probability of configuring a complaints chart to display complaint records, deviations, corrective and preventive actions (CAPA) associated with complaints, with a certain percentage probability for a particular enterprise. A complaints chart for another enterprise, for example, may include user identifier (e.g., ownerId, and/or the like), regulatory body, status, and/or the like. The one or more rules may be leveraged to determine configuration data for table(s), user assignment(s), data quer(ies), and/or other portions of a given chapter, which can vary for the same product between different enterprises. In some embodiments, the one or more rules may be industry specific. In some embodiments, the one or more rules may be product specific.

In some embodiments, the report generation system 108 may be configured to perform one or more report generation operations associated with generation of reports 322, for example, quality reports. In some embodiments, the report generation operation(s) performed by the report generation system 108 may comprise retrieving relevant data 312 from among the enterprise data 302 based at least in part on the configuration data for the report 322. The relevant data 312 may comprise any data from among the enterprise data 302 that may be used in generation of the reports 322.

In some embodiments, the report generation operation(s) performed by the report generation system 108 may comprise prompting for, receiving, and/or processing report the relevant data 312 and/or configuration data in connection with generation of the reports 322.

In some embodiments, the report generation operation(s) performed by the report generation system 108 may comprise generating and/or outputting the reports 322, including generating one or more particular report portions (e.g., chapters, sub-chapter, section, and/or the like) associated with a report 322 and/or generating a complete report 322 comprising all particular report portions generated in connection with the report 322. In one example, the report generation system 108 may be configured to generate the reports 322 based at least in part on the retrieved relevant data 312, and/or any data derived from the retrieved relevant data 312 by including some or all of data within the generated reports 322, formatting the reports 322, and/or performing other operations associated with generating reports.

In some examples, particular portions of the enterprise data 302 included in the retrieved relevant data 312 may correspond to and/or may be determined based at least in part on the configuration data. For example, in response to identifying, based at least in part on the configuration data, a particular report portion (e.g., chapter) defined as part of a configuration for generating a report, the report generation system 108 may be configured to retrieve (as part of the relevant data 312
one or more portions of the enterprise data 302 specifically associated with the particular report portion identified within the configuration data. As another example, in response to identifying, based at least in part on the configuration data, data associated with a particular product, the report generation system 108 may be configured to retrieve (as part of the relevant data 312) one or more portions of the enterprise data 302 specifically associated with that particular product and to perform the report generation operation(s) with respect to and/or based at least in part on the retrieved portion(s) of the enterprise data 302. As yet another example, in response to identifying, based at least in part on the configuration data a particular data set indicated to be associated with a configuration step, the report generation system 108 may be configured to retrieve (as part of the relevant data 312) one or more portions of the enterprise data 302 specifically associated with the particular data sets, including the particular data sets themselves or portions thereof.

The report generation system 108 may be configured to prompt for, receive, and/or process the relevant data 312 based at least in part on the configuration data. In some embodiments, the report generation system 108 may be configured to perform the report generation operation(s) in a particular order or sequence based at least in part on the configuration data. For example, in response to identifying, based at least in part on the configuration data, a particular sequence or order of configuration steps and/or report generation phases, the report generation system 108 may be configured to perform the report generation operation(s) corresponding to the various steps and/or phases according to the particular sequence or order of the steps/phases defined in the configuration data.

In some embodiments, the report generation system 108 may be configured to perform the report generation operation(s) with respect to particular users and/or corresponding user accounts based at least in part on the configuration data. For example, in response to identifying, based at least in part on the configuration data, an assignment of a user to a particular configuration step or report generation phase, the report generation system 108 may be configured to perform report generation operation(s) associated with that particular step/phase specifically with respect to the assigned user, including performing the report generation operation(s) specifically in conjunction with a particular user device 104 (e.g., particular user device) associated with the assigned user and/or presenting any interface(s) for receiving any relevant data 312 associated with that particular step/phase specially to the assigned user (e.g., via the user device 104 associated with the assigned user), to list a few examples.

In various embodiments, the report generation system 108 may be configured to generate report status data in connection with and/or based at least in part on performance of the various report generation operation(s). For example, in response to completion of a particular report generation operation, the report generation system 108 may be configured to generate and/or update the report status data to reflect and/or indicate that the particular report generation operation was completed. In some embodiments, the report generation system 108 may be configured to generate the report status data to be interpretable by the configuration recommendation system 102, including, for example, generating the report status data such that formatting and/or contents of the data may be suitable for parsing and/or interpretation by the configuration recommendation system 102.

In various embodiments, the report generation system 108 may be configured to generate and/or update the report status data by adding and/or updating data identifying, characterizing, and/or providing display labels associated with particular types of statuses with respect to particular types of steps and/or report generation phases. For example, in addition to indicating, for certain steps/phases a binary completion status (e.g., complete, incomplete) the report status data may comprise data characterizing the completion status and/or describing the current iteration of a report (or portion thereof), including, for example, labels or tags indicating which particular operations still remain to be completed, which particular operations were most recently completed, which particular operations are currently in progress, approval or rejection statuses associated with particular reports (or portions thereof), and/or draft status of a particular report (or portion thereof), to list a few examples.

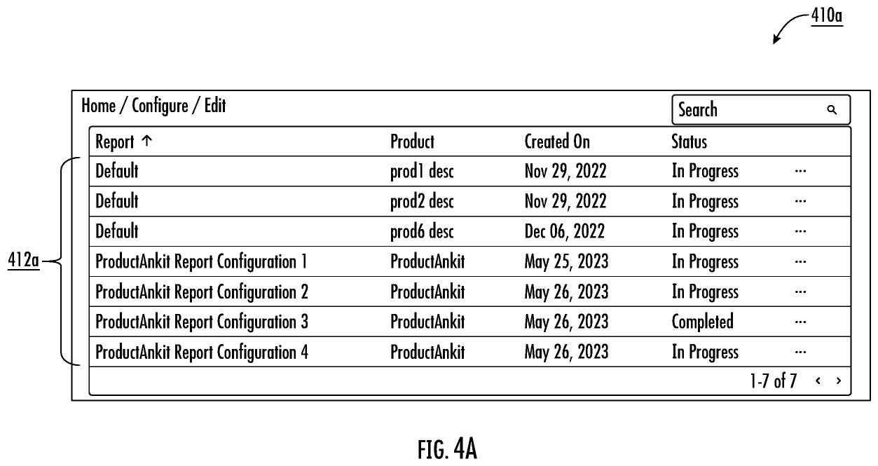

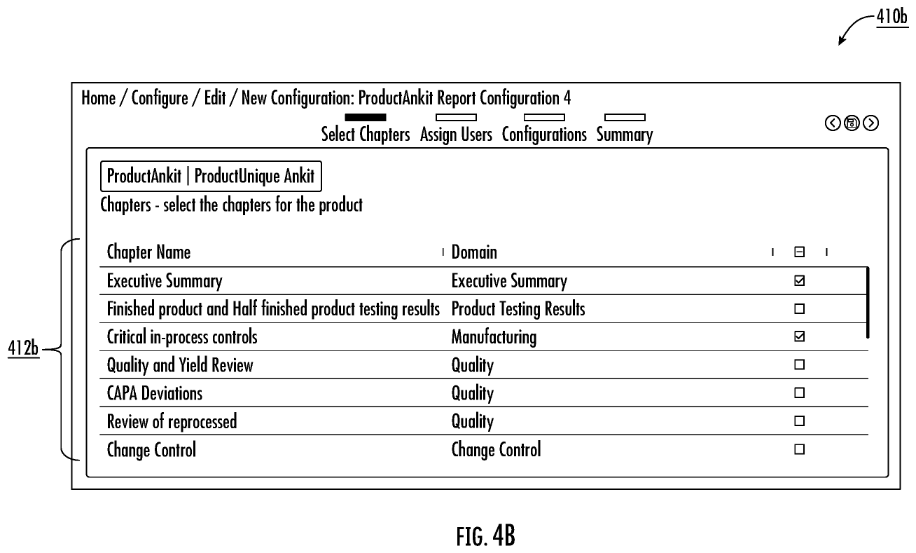

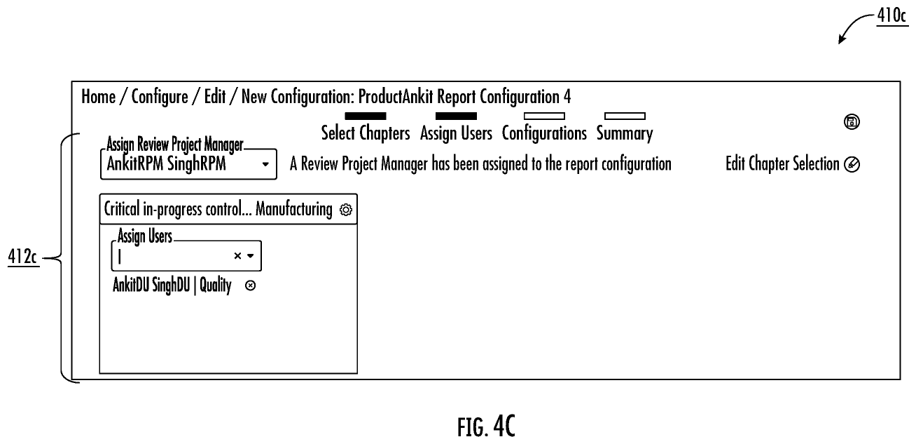

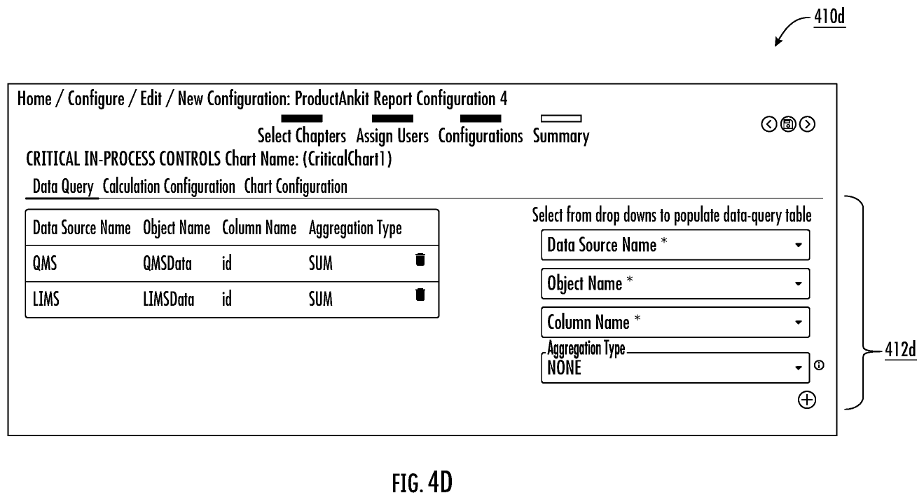

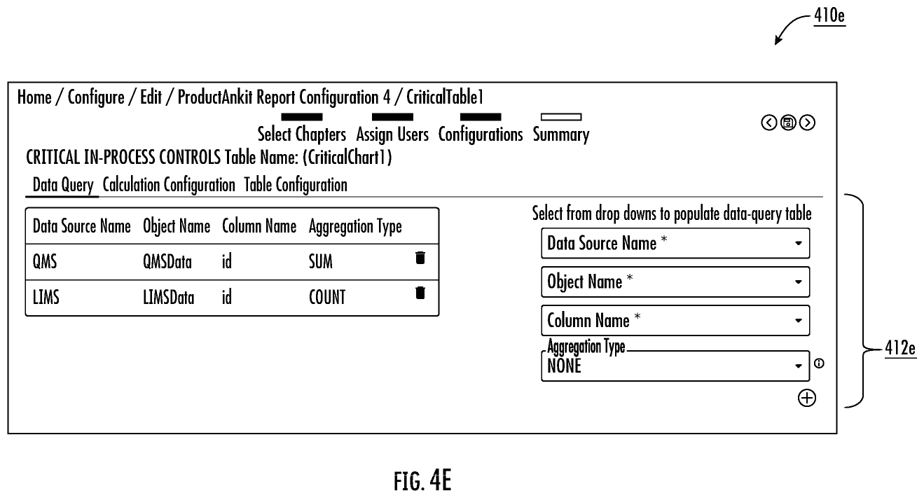

FIGS. 4A-4C provide illustration of exemplary configuration user interfaces 410a-n. The configuration user interfaces 410a-n may be rendered on a display of a computing device such as a user device 104. The configuration user interfaces 410a-n may be presented as part of a native application user interface or a user interface of a web application (e.g., rendered via a web browser application). The configuration user interfaces 410a-n may comprise interface elements configured to receive data objects representing configuration data (e.g., as described above in connection with FIG. 3).

FIG. 4A is illustrates an example report configuration user interface in accordance with at least one example embodiment of the present disclosure. As shown in FIG. 4A, in some embodiments, the exemplary configuration user interfaces 410a-n may comprise report configuration user interface 410a corresponding to a report configuration node of a configuration workflow. Within the report configuration user interface 410a may be rendered one or more interface elements 412a. Each of the one or more interface elements 412a which may be associated with a particular report such that any input (e.g., one or more data objects) received with respect to the one or more interface elements 412a may be indicative of the report type to generate and/or indicative of continuation of a particular report whose configuration is in progress

FIG. 4B illustrates an example chapter configuration user interface in accordance with at least one example embodiment of the present disclosure. As shown in FIG. 4B, in some embodiments, the exemplary configuration user interfaces 410a-n may comprise chapter configuration user interface 410b corresponding to a chapter configuration node of a configuration workflow. Within the chapter configuration user interface 410b may be rendered one or more interface elements 412b. Each of the one or more interface elements 412b may be associated with a particular chapter that may be included in a report, such that any input (e.g., one or more data objects) received with respect to a particular interface element 412b may be indicative of the chapter to include in the report being configured.

FIG. 4C illustrates an example user configuration user interface in accordance with at least one example embodiment of the present disclosure. As shown in FIG. 4C, In some embodiments, the exemplary configuration user interfaces 410a-n may comprise user configuration user interface 410c corresponding to a user configuration node of a configuration workflow. Within the user configuration user interface 410c may be rendered one or more interface elements 412c. Each of the one or more interface elements 412c may correspond to a user configuration input parameter (e.g., username, user account, user role, and/or the like), such that any input (e.g., one or more data objects) received with respect to the one or more interface element 412c may be indicative of assignment of a particular user and/or user account represented in the input to a corresponding chapter.

FIG. 4D illustrates an example chart configuration user interface in accordance with at least one example embodiment of the present disclosure. As shown in FIG. 4D, In some embodiments, the exemplary configuration user interfaces 410a-n may comprise chart configuration user interface 410d corresponding to a chart configuration node of a configuration workflow. Within the chart configuration user interface 410d may be rendered one or more interface elements 412d. Each of the one or more interface elements 412d may correspond to a chart configuration input parameter, such that any input (e.g., one or more data objects) received with respect to the one or more interface element 412d may be indicative of one or more database selections and/or field names with respect to the one or more databases to retrieve the relevant data for generating and/or otherwise population the chart.

FIG. 4E illustrates an example table configuration user interface in accordance with at least one example embodiment of the present disclosure. As shown in FIG. 4E, In some embodiments, the exemplary configuration user interfaces 410a-n may comprise table configuration user interface 410e corresponding to a table configuration node of a configuration workflow. Within the table configuration user interface 410e may be rendered one or more interface elements 412e. Each of the one or more interface elements 412e may correspond to a table configuration input parameter, such that any input (e.g., one or more data objects) received with respect to the one or more interface element 412e may be indicative of one or more database selections and/or field names with respect to the one or more databases to retrieve the relevant data for generating and/or otherwise population the table.

### Example Processes of the Disclosure

Having described example apparatuses, systems, data flows, user interfaces, and environments in accordance with the disclosure, processes for generating and/or presenting configuration data for configuring a report in accordance with the disclosure will now be described. It will be appreciated that each of the flowcharts depicts an example computer-implemented process that is performable by one or more of the apparatuses, systems, devices, and/or computer program products described herein, for example utilizing one or more of the specially configured components thereof.

Although the example processes depicts a particular sequence of operations, the sequence may be altered without departing from the scope of the present disclosure. For example, some of the operations depicted may be performed in parallel or in a different sequence that does not materially affect the function of the processes.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

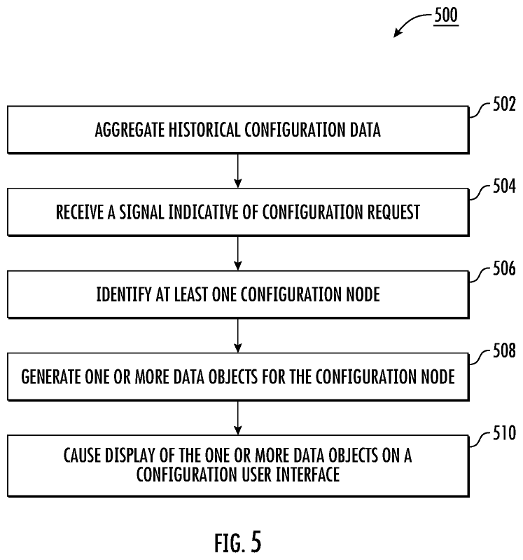

FIG. 5 illustrates a flowchart depicting operations of an example process for intelligent report configuration in accordance with at least one example embodiment of the present disclosure. Specifically, FIG. 5 depicts an example process 500. In some embodiments, the process 500 is embodied by computer program code stored on a non-transitory computer-readable storage medium of a computer program product configured for execution to perform the process as depicted and described. Alternatively or additionally, in some embodiments, the process 500 is performed by one or more specially configured computing devices, such as the apparatus 200 alone or in communication with one or more other component(s), device(s), system(s), and/or the like. In this regard, in such some embodiments, the apparatus 200 is specially configured by computer-coded instructions (e.g., computer program instructions) stored thereon, for example in the memory 204 and/or another component depicted and/or described herein and/or otherwise accessible to the apparatus 200, for performing the operations as depicted and described. In some embodiments, the apparatus 200 is in communication with one or more external apparatus(es), system(s), device(s), and/or the like, to perform one or more of the operations as depicted and described. For example, the apparatus 200 in some embodiments is in communication with at least one external data repository, client system, and/or the like, to perform one or more of the operation(s) as depicted and described. For purposes of simplifying the description, the process 500 is described as performed by and from the perspective of the apparatus 200.

According to some examples, the method includes aggregating historical configuration data based at least in part on a plurality of historical reports at operation 502. In some embodiments, the plurality of historical reports are associated with a plurality of entities (e.g., plurality of enterprise) having at least one characteristic in common. In some embodiments, the at least one characteristic includes substantially similar industry (e.g., pharmaceutical industry, automotive industry, and/or the like), substantially similar product types, and/or the like. For example, the plurality of historical reports may be associated with a plurality of enterprises that manufacture the same product type. Alternatively or additionally, in some embodiments, the plurality of historical reports are associated with an individual entity, for example, a single enterprise.

According to some examples, the method includes receiving a signal indicative of a configuration request for a report having a hierarchical data structure at operation 504. In some embodiments, the signal is received from a user device, such as user device 104.

According to some examples, the method includes identifying at least one configuration node of a report configuration workflow for configuring the report at operation 506. In some embodiments, the report configuration workflow is defined by a hierarchical arrangement of a plurality of configuration nodes corresponding to the hierarchical data structure of the report. In some embodiments, the plurality of configuration nodes comprises at least one chapter configuration node configured for defining one or more chapters for the report, and one or more user configuration nodes for each of the one or more chapters, wherein each user configuration node for a chapter is configured to enable configuration of one or more user assignments for the chapter. Alternatively or additionally, in some embodiments, the plurality of configuration nodes comprises one or more chart configuration nodes for each of the one or more chapters, wherein each chart configuration node for a chapter is configured to enable configuration of one or more charts for the chapter. Alternatively or additionally, in some embodiments, the plurality of configuration nodes comprises one or more table configuration nodes for each of the one or more chapters, wherein each table configuration node for a chapter is configured to enable configuration of one or more tables for the chapter. Alternatively or additionally, in some embodiments, the plurality of configuration nodes comprises one or more calculation configuration nodes for each of the one or more chapters, wherein each calculation configuration node for a chapter is configured to enable configuration of one or more calculations for the chapter. In some embodiments, the historical configuration data comprises one or more segments, wherein each segment corresponds to a particular configuration node of the plurality of configuration nodes of the configuration workflow.

According to some examples, the method includes generating, based at least in part on the historical configuration data and using one or more models, one or more data objects for the at least one configuration node at operation 508. In such some embodiments, the one or more data objects are indicative of at least a portion of the configuration data for one or more portions of the report. In some embodiments, at least one model of the one or more models is trained to generate at least one data object for each of the one or more chapters based at least in part on a similarity measure between subsets of the historical configuration data. Each subset of the historical configuration data may be associated with a particular historical report of the plurality of historical reports. In some embodiments, at least one model of the one or more models is trained to generate at least one data object for each of the one more chapters based at least in part on the historical configuration data and real-time data indicative of at least a workload for each of one or more candidate users.

In some embodiments, at least one model of the one or more models is trained to generate at least one data object for each of the one more chapters based at least in part on performing trend analysis with respect to the historical configuration data. For example, the at least one model may be configured to perform one more trend analysis operations with respect to database names, column names, calculation types, table names, and/or the like based at least in part on the historical configuration data. The at least one model, based at least in part on the one or more trend analysis operations, may generate and/or present data object(s) representing configuration data (e.g., database name, column name, calculation type, table name, and/or the like) for a table configuration node for configuring one or more tables for one or more chapters of the report. As another example, the at least one model may be trained to perform one more trend analysis operations with respect to database names, coordinates (e.g., x-axis, y-axis, and/or the like), calculation types, chart names, and/or the like based at least in part on the historical configuration data. The at least one model, based at least in part on the one or more trend analysis operations, may generate and/or present data object(s) representing configuration data (e.g., database name, column name, calculation type, table name, and/or the like) for a chart configuration node associated with configuring a report, such as the report 322, for configuring one or more tables for one or more chapters of the report.

According to some examples, the method includes causing display of the one or more data objects on a configuration user interface rendered on a user device at operation 510. In some embodiments, the apparatus 200 may be configured to render the configuration user interface on the user device. In some embodiments, the configuration user interface comprises one or more of a chapter configuration user interface, a user configuration user interface, a chart configuration user interface, or a table configuration user interface.

### Conclusion

Many modifications and other embodiments of the disclosure set forth herein will come to mind to one skilled in the art to which this disclosure pertains having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method for intelligent report configuration, the method comprising:
aggregating historical configuration data based at least in part on a plurality of historical reports;
receiving a signal indicative of a configuration request for a report having a hierarchical data structure;
identifying at least one configuration node of a report configuration workflow for configuring the report, the report configuration workflow defined by a hierarchical arrangement of a plurality of configuration nodes corresponding to the hierarchical data structure of the report;
generating, based at least in part on the historical configuration data and using one or more models, one or more data objects for the at least one configuration node, the one or more data objects indicative of at least a portion of the configuration data for one or more portions of the report;
causing display of the one or more data objects on a configuration user interface rendered on a user device.

2. The computer-implemented method of claim 1, wherein the signal is received from the user device.

3. The computer-implemented method of claim 1, wherein the plurality of historical reports are associated with a plurality of entities having at least one characteristic in common.

4. The computer-implemented method of claim 1, wherein the plurality of historical reports are associated with an individual entity.

5. The computer-implemented method of claim 1, wherein the plurality of configuration nodes comprises at least one chapter configuration node configured for defining one or more chapters for the report, and one or more user configuration nodes for each of the one or more chapters, wherein each user configuration node for a chapter is configured to enable configuration of one or more user assignments for the chapter.

6. The computer-implemented method of claim 5, wherein the plurality of configuration nodes further comprises one or more chart configuration nodes for each of the one or more chapters, wherein each chart configuration node for a chapter is configured to enable configuration of one or more charts for the chapter.

7. The computer-implemented method of claim 1, wherein at least one model of the one or more models is trained to generate at least one data object for each of the one or more chapters based at least in part on a similarity measure between subsets of the historical configuration data, wherein each subset of the historical configuration data is associated with a particular historical report of the plurality of historical reports.

8. The computer-implemented method of claim 1, wherein at least one model of the one or more models is trained to generate at least one data object for each of the one more chapters based at least in part on the historical configuration data and real-time data indicative of at least a workload for each of one or more candidate users.

9. The computer-implemented method of claim 1, wherein the configuration user interface comprises one or more of a chapter configuration user interface, a user configuration user interface, a chart configuration user interface, or a table configuration user interface.

10. The computer-implemented method of claim 1, wherein the historical configuration data comprises one or more segments, wherein each segment corresponds to a particular configuration node of the plurality of configuration nodes.

11. An apparatus for intelligent report configuration, the apparatus comprising at least one processor and at least one memory storing instructions that, when executed by the at least one processor, cause the apparatus to:
aggregate historical configuration data based at least in part on a plurality of historical reports;
receive a signal indicative of a configuration request for a report having a hierarchical data structure;
identify at least one configuration node of a report configuration workflow for configuring the report, the report configuration workflow defined by a hierarchical arrangement of a plurality of configuration nodes corresponding to the hierarchical data structure of the report;
generate, based at least in part on the historical configuration data and using one or more models, one or more data objects for the at least one configuration node, the one or more data objects indicative of at least a portion of the configuration data for one or more portions of the report:
cause display of the one or more data objects on a configuration user interface rendered on a user device.

12. The apparatus of claim 11, wherein the signal is received from the user device.

13. The apparatus of claim 11, wherein the plurality of historical reports are associated with a plurality of entities having at least one characteristic in common.

14. The apparatus of claim 11, wherein the plurality of historical reports are associated with an individual entity.

15. The apparatus of claim 11, wherein the plurality of configuration nodes comprises at least one chapter configuration node configured for defining one or more chapters for the report, and one or more user configuration nodes for each of the one or more chapters, wherein each user configuration node for a chapter is configured to enable configuration of one or more user assignments for the chapter.

16. The apparatus of claim 15, wherein the plurality of configuration nodes further comprises one or more chart configuration nodes for each of the one or more chapters, wherein each chart configuration node for a chapter is configured to enable configuration of one or more charts for the chapter.

17. The apparatus of claim 11, wherein at least one model of the one or more models is trained to generate at least one data object for each of the one or more chapters based at least in part on a similarity measure between subsets of the historical configuration data, wherein each subset of the historical configuration data is associated with a particular historical report of the plurality of historical reports.

18. The apparatus of claim 11, wherein at least one model of the one or more models is trained to generate at least one data object for each of the one more chapters based at least in part on the historical configuration data and real-time data indicative of at least a workload for each of one or more candidate users.

19. The apparatus of claim 11, wherein the configuration user interface comprises one or more of a chapter configuration user interface, a user configuration user interface, a chart configuration user interface, or a table configuration user interface.

20. A computer program product for intelligent report configuration, the computer program product comprising at least one non-transitory computer-readable storage medium, the at least one non-transitory computer-readable storage medium including instructions that when executed by at least one processor, cause the computer to:
aggregate historical configuration data based at least in part on a plurality of historical reports;
receive a signal indicative of a configuration request for a report having a hierarchical data structure;
identify at least one configuration node of a report configuration workflow for configuring the report, the report configuration workflow defined by a hierarchical arrangement of a plurality of configuration nodes corresponding to the hierarchical data structure of the report;
generate, based at least in part on the historical configuration data and using one or more models, one or more data objects for the at least one configuration node, the one or more data objects indicative of at least a portion of the configuration data for one or more portions of the report;
cause display of the one or more data objects on a configuration user interface rendered on a user device.
